(19) United States
(12) Patent Application Publication
(10) Pub. No.: US 2022/0091838 A1
(43) Pub. Date: Mar. 24, 2022

(54) COMPONENT FIRMWARE UPDATES

(71) Applicant: Hewlett-Packard Development Company, L.P., Spring, TX (US)

(72) Inventors: MingHong Lee, Taipei City (TW); Yi-Fan Hsia, Taipei City (TW); Ming Chang Hung, Taipei City (TW); Hung Lung Chen, Taipei City (TW)

(73) Assignee: Hewlett-Packard Development Company, L.P., Spring, TX (US)

(21) Appl. No.: 17/295,028

(22) PCT Filed: Jun. 11, 2019
(86) PCT No.: PCT/US2019/036440

§ 371 Date: May 18, 2021

(51) Int. Cl. G06F 8/65; G06F 8/61; G06F 8/41; G06F 9/4401

(52) U.S. Cl. CPC G06F 8/65; G06F 9/4406; G06F 8/433; G06F 8/61

(57) ABSTRACT

In one example, a computing device may include a processor and a memory in communication with the processor. The memory may include a firmware update logic executable by the processor to detect an external device connected to the computing device, determine that a first component firmware and a second component firmware on the external device are to be updated, and perform an update of the first component firmware in parallel with an update of the second component firmware on the external device.

### BACKGROUND

Docking stations, also referred to as port replicators, have various ports for connecting to different peripheral devices such as a keyboard, mouse, audio/video output, storage device, or the like. Each port may have a separate function (e.g., audio, video, power, and the like). When a computing device is docked with the docking station, the ports can be provided as if the peripheral devices were the part of the computing device. Thus, the computing device can be allowed to connect with various peripheral devices than would be possible using the ports on the computing device.

### BRIEF DESCRIPTION OF THE DRAWINGS

Examples are described in the following detailed description and in reference to the drawings, in which:

FIG. 1A is a block diagram of an example computing device, including a firmware update logic to update a first component firmware in parallel with an update of a second component firmware on an external device;

FIG. 1B is a block diagram of the example computing device of FIG. 1A, depicting additional features;

FIG. 2 is a block diagram of an example computing device, including a firmware update logic to perform a first firmware update of a first component in parallel with a second firm update of a second component based on a dependency relationship;

FIG. 3 is a block diagram of the example computing device of FIG. 2, including the firmware update logic to perform firmware update of multiple components of n external device in parallel based on analyzing, a component tree structure; and

FIG. 4 is a block diagram of an example computing device including a non-transitory machine-readable storage medium, storing instructions to perform an update of a first component firmware in parallel with an update of a second component firmware on an external device.

### DETAILED DESCRIPTION

Many computing devices may have ports to connect to and interface with peripheral devices. Such ports may implement the universal serial bus (USB) standard. The physical interface specifications of the USB standard may allow for a variety of peripheral devices to be connected to a computing device using a simple and standardized socket. Example peripheral devices may include external hard drives, displays, monitors, mice, keyboards, wireless network adapters, scanners, printers, and the like.

However, the peripheral devices can also be connected to the computing device via a docking station. The docking station may provide the computing device with a “one stop” quick connection to the peripheral devices that are included in the docking station. In other words, the docking station may be used to extend an input/output (IO) port array of the computing device and provide a means for the computing device to hook up to a variety of peripheral devices. The docking station may be connected to the computing device, for instance, by a USB interface or a wireless interface. The peripheral devices may be connected to the docking station via a corresponding peripheral port, a wireless interface, or a combination thereof. Example peripheral ports may include a display port, USB-C port, USB-A port, video graphics array (VGA) port, network interface card (NIC), earphone, audio module, and the like.

Further, the docking station may include various components (e.g., integrated circuits (ICs)) that serve to operatively connect the computing device to the peripheral devices when the computing device is plugged into the docking station. In some examples, the docking station may include multiple components from different vendors integrated together. Example components may include Microcontroller unit (MCU), a dual USB type-C controller, an audio codec, a local area network (LAN) controller, a Universal Serial Bus (USB) hub controller, a USB power delivery (PD) controller, and the like to support and control various peripheral ports or interfaces of the docking station. Further, the docking station may include multiple firmware to support such components. The firmware upgrade process supported by each component vendor or IC manufacturer may be different.

Some example methods for docking firmware update may facilitate one-click firmware upgrades to multiple components from different vendors. However, the docking firmware update may follow a serial sequence (e.g., update one component after other) to update firmware for the components of the docking station, thereby consuming a significant amount of time to complete the docking firmware update for the components.

Examples described herein may determine components of a docking station, for which the firmware can be updated in parallel. In one example, the components for which the firmware can be updated in parallel may be determined based on dependency relationship between the components. Further, examples described herein may perform firmware update of the components of the docking station in parallel. Thus, examples described herein may enable parallelization of the firmware update for the components of the docking station to reduce overall time for completing the firmware update, process.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in that one example, but not necessarily in other examples.

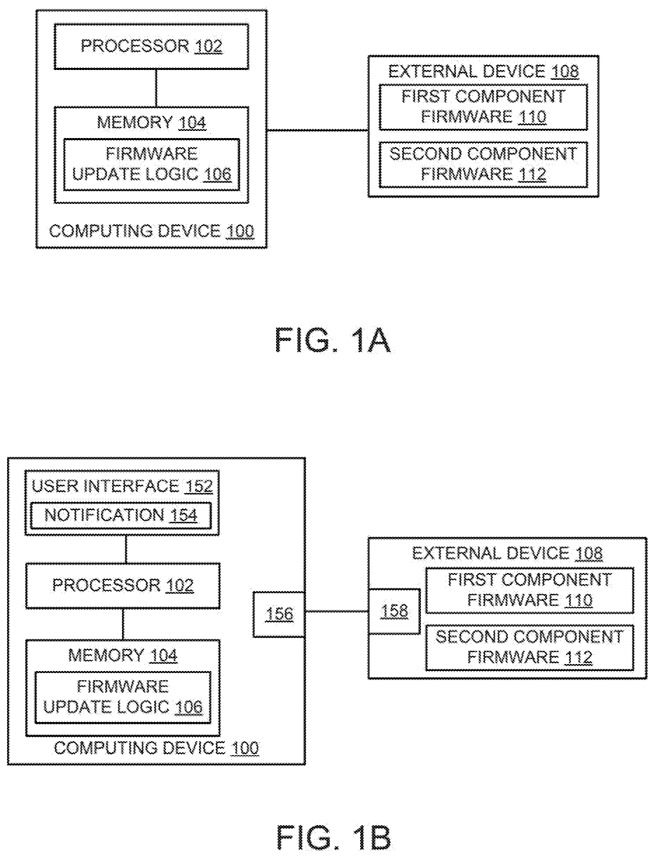

Turning now to the figures, FIG. 1A is a block diagram of an example computing device 100, including a firmware update logic 106 to update a first component firmware 110 in parallel with an update of a second component firmware 112 on an external device 108. Example computing device 100 may include a notebook computer, a tablet computer, a personal computer (PC), a smartphone, a gaming laptop, a workstation, a convertible device, or the like. Example convertible device may refer to a device that can be “convertible” from a laptop mode to a tablet mode. Example external device 108 may be a docking station including multiple component firmware, for instance, to support multiple components.

Further, example computing device 100 may include a processor 102 and a memory 104 in communication with processor 102. Memory 104 may include firmware update logic 106 executable by processor 102 to update first component firmware 110 in parallel with second component firmware 112 on external device 108.

Firmware update logic 106 may be implemented in hardware, machine-readable instructions, or a combination thereof. Firmware update logic 106 may be implemented as engines or modules comprising any combination of hardware and programming to implement the functionalities described herein. In other examples, firmware update logic 106 care be implemented with a microcontroller, an application-specific integrated circuit (ASIC), a programmable gate array (PGA) or any other type of hardware component.

During operation, firmware update logic 106 may detect external device 108 connected to computing device 100. When computing device 100 is docked with external device 108, for instance via a wired interface or a wireless interface, firmware update logic 106 may detect a connection between external device 108 and computing device 100.

Further, firmware update logic 106 may determine that first component firmware 110 and second component firmware 112 on external device 108 may have to be updated. Furthermore, firmware update logic 106 may determine components, for which the firmware can be updated in parallel. Then, firmware update logic 106 may perform the update of first component firmware 110 in parallel with the update of second, component firmware 112 on external device 108.

FIG. 1B is a block diagram of example computing device 100 of FIG. 1A, depicting additional features. For example, similarly named elements of FIG. 1B may be similar in structure and/or function to elements described with respect to FIG. 1A. As shown in FIG. 1B, computing device 100 may include a port 156 to couple external device 108 to computing device 100. Example port 156 may be a universal serial bus (USB) type-C port. External device 108 may include a host interface 158 to enable one wire connectivity of display port video, USB 3.0 data, and charging between computing device 100 and external device 108. Further, External device 108 may be provided with various peripheral ports such as a display port, USB-C port, USB-A port, video graphics array (VGA) port, network interface card (NIC), earphone, audio module (e.g., a microphone, volume up/down, hang off, and call), and/or the like. External device 108 may provide computing device 100 with a connection to peripheral devices that are included in external device 108 through the peripheral ports.

Further, computing device 100 may include a user interface 152. User interface 152 may be rendered on a display of computing device 100. Example display may include liquid crystal display (LCD), light emitting diode (LED) display, electro-luminescent (EL) display, or the like. In one example, firmware update logic 106 may generate a notification 154 on user interface 152 of computing device 100. Notification 154 may include an option to update first component firmware 110 and second component firmware 112. Example option may include a first option to perform the firmware update and a second option to postpone the firmware update. Further, firmware update logic 106 may perform the update of first component firmware 110 in parallel with the update of second component firmware 112 in response to a selection of the option.

In another example, firmware update logic 106 may perform the update of first component firmware 110 in parallel with the update of second component firmware 112 on external device 108 without user interaction when external device 108 is connected to computing device 100. In this example, external device 108 may have to be connected to computing device 100 when firmware update logic 106 is executed and may have to, stay connected till the completion of update of first component firmware 110 and second component firmware 112. Thus, firmware update logic 106 may run silently, loud, or non-interactively, which may show update status in UI 152, but may not require any action from the user.

In other examples, firmware update logic 106 may first download first component firmware 110 and second component firmware 112 to computing device 100 via a network, and then perform the update of first component firmware 110 in parallel with the update of second component firmware 112 on external device 108 when external device 108 is connected to computing device 100.

Thus, firmware update logic 106 may enable to deploy firmware updates to external device 108 that may or may not be connected to computing device 100 at the time of installation of the package. When a supported docking station (i.e., external device 108) is connected and the user is logged onto computing device 100, firmware update logic 106 may determine whether a firmware is to be updated. When the firmware is to be updated, UI 152 may be displayed for user consent for the firmware update. Upon user consent, update of first component firmware 110 and second component firmware 112 may be performed on external device 108 in parallel.

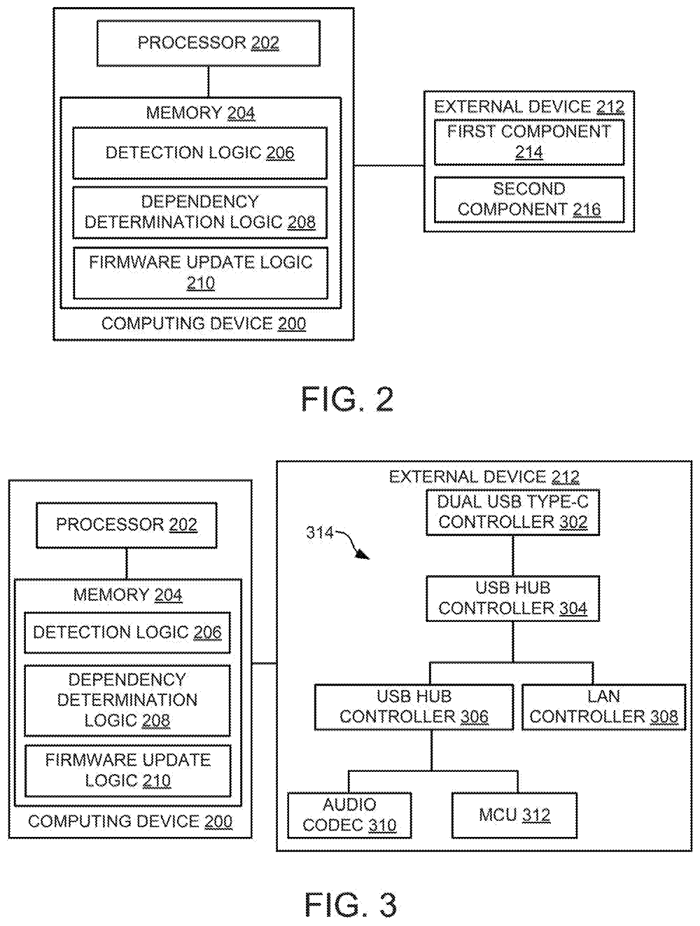

FIG. 2 is a block diagram of an example computing device 200, including a firmware update logic 210 to perform a first firmware update of a first component 214 in parallel with a second firmware update of a second component 216 based on a dependency relationship. Example computing device 200 may include a processor 202 and a memory 204 in communication with processor 202.

In one example, memory ay include a detection logic 206, a dependency determination logic 208, and firmware update logic 210 that are communicative with each other to perform the first firmware update and the second firmware update in parallel. Detection logic 206, dependency determination logic 208, and firmware update logic 210 may be implemented in hardware, machine-readable instructions, or a combination thereof. Detection logic 206, dependency determination logic 208, and firmware update logic 210 may be implemented as engines or modules comprising any combination of hardware and programming to implement the functionalities described herein. For example, detection logic 206, dependency determination logic 208, and firmware update logic 210 can be implemented with a microcontroller, an application-specific integrated circuit (ASIC), a programmable gate array (PGA), or any other type of hardware component.

During operation, detection logic 206 can be executable by processor 202 to detect an external device 212 connected to computing device 200. Example external device 212 may be a docking station. Further, external device 212 may include various components such as first component 214, second component 216, a third component and the like. The components may refer to ICs that serve to operatively connect computing device 200 to various peripheral devices when computing device 200 is plugged into the docking station.

Further, dependency determination logic 208 can be executable by processor 202 to determine a dependency relationship between first component 214 and second component 216 of external device 212. In one example, dependency determination logic 208 may be executable by processor 202 to retrieve a component tree structure including the dependency relationship between first component 214 and second component 216 of external device 212. Example component tree structure may include leaf components that may have no dependencies and components at a higher level that have dependencies. Further, dependency determination logic 208 may determine the dependency relationship between first component 214 and second component 216 based on analyzing the component tree structure. An example component tree structure is shown in FIG.

Furthermore, firmware update logic 210 can be executable by processor 202 to perform a first firmware update of first component 214 in parallel with a second firmware update of second component 216 based on the dependency relationship. In one example, firmware update logic 210 may be executable by processor 202 to perform the first firmware update in parallel with the second firmware update when first component 214 does not have dependency relationship with second component 216.

In some examples, firmware update logic 210 may be executable by processor 202 to perform the first firmware update of first component 214 in parallel with the second firmware update of second component 216 of external device 212 at a first level. Further, firmware update logic 210 may be executable by processor 202 to perform a third firmware update associated with a third component of external device 212 at a second level upon successfully completing the first firmware update and the second firmware update. In this example, the second level may be a higher level than the first level in the component tree structure and the third component may have a dependency relationship with first component 214 or second component 216. An example firmware update process may be explained in FIG. 3.

FIG. 3 is a block diagram of example computing device 200 of FIG. 2, including firmware update logic 210 to perform firmware update of multiple components 302-312 of external device 212 in parallel based on analyzing a component tree structure 314. For example, similarly named elements of FIG. 3 may be similar in structure and/or function to elements described with respect to FIG. 2.

As shown in FIG. 3, external device 212 may include multiple components such as dual USB Type-C controller 302, USB hub controllers 304 and 306 from different IC manufacturers, a LAN controller 308, an audio codec 310, and an MCU 312. Components 302-312 may refer to ICs that serve to operatively connect computing device 200 to the peripheral devices when computing device 200 is plugged into external device 212. In some examples, components 302-312 may be manufactured by different vendors. The firmware upgrade process supported by each vendor or IC manufacturer may be different.

For example, dual USB Type-C controller 302 may comply with USB Type-C and power delivery (PD) standards and also provide a complete dual USB Type-C and USB-power delivery port control solution for computing device 200, external device 212, and the peripheral devices. USB hub controllers 304 and 306 may support respective USB ports and perform respective operations such as controlling charging of peripheral devices through USB ports. USB hub controllers 304 and 306 may be associated with different IC manufacturers. LAN controller 308 may support an Ethernet port or a LAN port and control Ethernet communications between computing device 200, external device 212, and the peripheral devices. Audio codec 310 may support audio ports to encode analog audio as digital signals and decodes digital back into analog. Similarly, external device 212 may include various other components, each having a respective function. Further, external device 212 may include multiple firmware to support components 302-312.

Further, FIG. 3 depicts component tree structure 314 of components 302-312. A component may be unstable, reset, or defeatured during the firmware update process. Therefore, firmware of a component cannot be updated when a dependent component at a higher level is performing the firmware update. For example, component firmware of audio codec 310 and MCU 312 may not be updated when USB hub controller 306 is performing the firmware update. In this example, when audio codec 310 and MCU 312 are updated while USB hub controller 306 is performing the firmware update, data associated with audio codec 310 and MCU 312 can be lost because USB hub controller 306 is unstable, reset, or defeatured during the firmware update process.

Therefore, dependency determination logic 208 may determine the component firmware update sequence and firmware update logic 210 may execute the determined sequence for component tree structure 314 as follows:
1. Update the component firmware from bottom to up for each branch of component tree structure 314. In the example shown in FIG. 3, there are two branches of components, branch 1 including USB hub controller 306, audio codec 310, and MCU 312, and branch 2 including LAN controller 308. The bottom components (e.g., leaf components) of branch 1 are audio codec 310 and MCU 312. The bottom component of branch 2 is LAN controller 308. In one example, firmware update logic 210 may update firmware of audio codec 310, MCU 312, and LAN controller 308 in parallel when the firmware update process is triggered.
2. Upon completing firmware, update of bottom components 308, 310, and 312, firmware update logic 210 may update a higher level for each branch. However, the component firmware cannot be updated if an associated child level or lower level component is performing the firmware update. For example, firmware update logic 210 may update USB hub controller 306 when the firmware update for audio codec 310 and MCU 312 are completed. Further, firmware update logic 210 may update USB hub controller 304 when the firmware update for USB hub controller 306, LAN controller 308, audio codec 310, and MCU 312 are completed.
3. Using the above firmware update process, dependency determination logic 208 may decide the firmware update sequence of components 302-312 as follows:
   a. Update LAN controller 308, audio codec 310, and MCU 312 in parallel.
   b. Update USB hub controller 306 and LAN controller 308 in parallel when LAN controller 308 does not complete the firmware update in step a.
   c. Update USB hub controller 304.
   d. Update Dual USB Type-C controller 302.
4. Firmware update logic 210 may execute the above determined sequence to perform the firmware update process of some components in parallel. Thus, examples described herein can update the component firmware quickly because the firmware for some, components of external device 212 can be updated in parallel.

Computing device 100 of FIGS. 1A and 1B or computing device 200 of FIGS. 2 and 3 may include computer-readable storage medium including (e.g., encoded with) instructions executable by a processor to implement functionalities described herein in relation to FIGS. 1A-3. In some examples, the functionalities described herein, in relation to instructions to implement functions of components of computing device 100 or 200 and any additional instructions described herein in relation to the storage medium, may be implemented as engines or modules including any combination of hardware and programming to implement the functionalities of the modules or engines described herein. The functions of components of computing device 100 or 200 may also be implemented by a respective processor. In examples described herein, the processor may include, for example, one processor or multiple processors included in a single device or distributed across multiple devices.

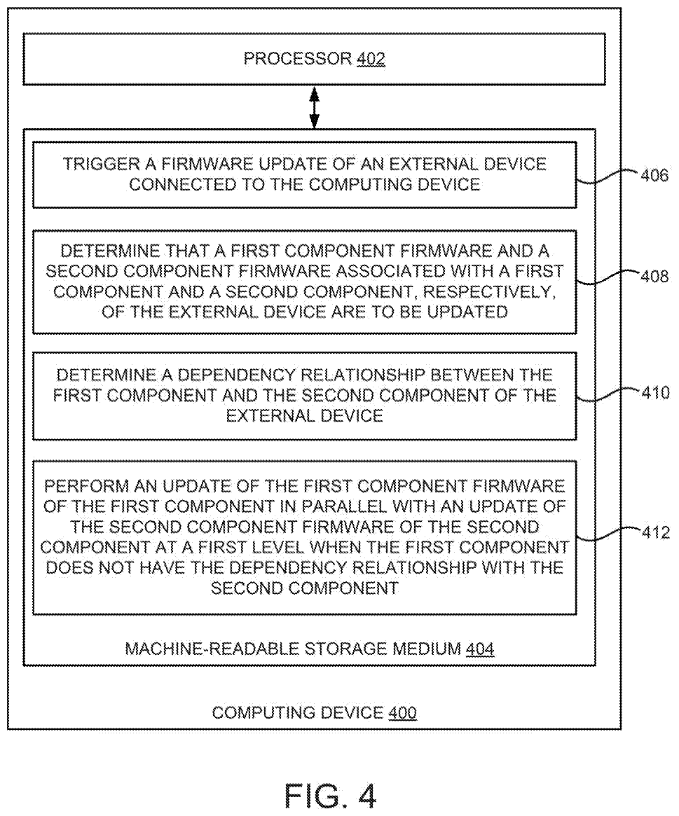

FIG. 4 is a block diagram of an example computing device 400 including a non-transitory machine-readable storage medium 404, storing instructions 406 to 412 to perform an update of a first component firmware in parallel with an update of a second component firmware on an external device. Computing device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to computing device 400.

As shown in FIG. 4, machine-readable storage medium 404 may store instructions 406-412. In an example, instructions 406-412 may be executed by processor 402 to update the first component firmware in parallel with the update of the second component firmware. Instructions 406 may be executed by processor 402 to trigger a firmware update of an external device connected to the computing device, for instance, via a USB port. For example, the USB port may be a USB type-C connector and the external device may include a USB type-C plug to mate with the USB type-C connector. In one example, the firmware update of the external device may be triggered in response to receiving a user input for the firmware update.

Instructions 408 may be executed by processor 402 to determine that a first component firmware and a second component firmware associated with a first component and a second component, respectively, of the external device are to be updated.

Instructions 410 may be executed by processor 402 to determine a dependency relationship between the first component and the second component of the external device. In one example, instructions to determine the dependency relationship between the first component and the second component may include instructions to retrieve a component tree structure including a dependency relationship between a plurality of components including the first component and the second component and determine the dependency relationship between the first component and the second component based on analyzing the component tree structure.

Instructions 412 may be executed by processor 402 to perform an update of the first component firmware of the first component in parallel with an update of the second component firmware of the second component at a first level when the first component does not have the dependency relationship with the second component.

Further, machine-readable storage medium 404 may store instructions to update the first component firmware of the first component in, sequence with the second component firmware of the second component when the first component has the dependency relationship with the second component.

Furthermore, machine-readable storage medium 404 may store instructions to update a third component firmware associated with a third component of the external device at a second level upon successfully completing the update of the first component firmware and the second component firmware. The third component may have a dependency relationship with the first component or the second component.

The term “logic” is, generally defined as hardware and/or programing. As hardware, logic may include a processor (e.g., processing circuitry such as a controller, a microprocessor, digital signal processor, a programmable gate array, an application specific integrated circuit, combinatorial logic, or the like). As programming, logic may include an executable code in the form of an executable application, an application programming interface (API), a subroutine, a function, a procedure, an object method/implementation, an applet, a servlet, a routine, a source code, an object code, a shared library/dynamic load library, or instructions.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where some or all of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computing device comprising:
a processor; and
a memory in communication with the processor, the memory including a firmware update logic executable by the processor to:
detect an external device connected to the computing device;
determine that a first component firmware and a second component firmware on the external device are to be updated; and
perform an update of the first component firmware in parallel with an update of the second component firmware on the external device.

2. The computing device of claim 1, wherein the external device is docking station.

3. The computing device of claim 1, wherein the firmware update logic is executable by the processor to:
download the first component firmware and the second component firmware to the computing device via a network; and
perform the update of the first component firmware in parallel with the update of the second component firmware on the external device when the external device is connected to the computing device.

4. The computing device of claim 1, wherein the firmware update logic is executable by the processor to:
perform the update of the first component firmware in parallel with the update of the second component firmware on the external device without user interaction when the external device is connected to the computing device.

5. The computing device of claim 1, wherein the firmware update logic is executable by the processor to:
generate a notification on a user interface of the computing device, wherein the notification comprises an option to update the first component firmware and the second component firmware; and
perform the update of the first component firmware in parallel with the update of the second component firmware in response to a selection of the option.

6. A computing device comprising:
a processor; and
a memory in communication with the processor, the memory comprises:
a detection logic, executable by the processor, to detect an external device connected to the computing device;
a dependency determination logic, executable by the processor, to determine a dependency relationship between a first component and a second component of the external device; and
a firmware update logic, executable by the processor, to perform a first firmware update of the first component in parallel with a second firmware update of the second component based on the dependency relationship.

7. The computing, device of claim 6, wherein the firmware update logic is executable by the processor to:
perform the first firmware update in parallel with the second firmware update when the first component does not have the dependency relationship with the second component.

8. The computing device of claim 6, wherein the dependency determination logic is executable by the processor to:
retrieve a component tree structure including the dependency relationship between the first component and the second component of the external device, wherein the component tree structure comprises leaf components that have no dependencies and components at a higher level that have dependencies; and
determine the dependency relationship between the first component and the second component based on analyzing the component tree structure.

9. The computing device of claim 6, wherein the firmware update logic executable by the processor to:
perform the first firmware update of the first component in parallel with the second firmware update of the second component of the external device at a first level; and
perform a third firmware update associated with a third component of the external device at a second level upon successfully completing the first firmware update and the second firmware update, wherein the second level is a higher level than the first level in a component tree structure; and wherein the third component is to have a dependency relationship with the first component or the second component.

10. The computing device of claim 6, wherein the external device is a docking station.

11. A non-transitory machine-readable storage medium encoded with instructions that, when executed by a computing device, cause the computing device to:
trigger a firmware update of an external device connected to the computing device;
determine that a first component firmware and a second component firmware associated with a first component and a second component, respectively, of the external device are to be updated;
determine a dependency relationship between the first component and the second component of the external device; and
perform an update of the first component firmware of the first component in parallel with an update of the second component firmware of the second component at a first level when the first component does not have the dependency relationship with the second component.

12. The non-transitory machine-readable storage medium of claim 11, wherein instructions to determine the dependency relationship between the first component and the second component comprise instructions to:
retrieve a component tree structure including a dependency relationship between a plurality of components including the first component and the second component; and
determine the dependency relationship between the first component and the second component based on analyzing component the tree structure.

13. The non-transitory machine-readable storage medium of m 11, further comprising instructions to:
update the first component firmware of the first component in sequence with the second component firmware of the second component when the first component has the dependency relationship with the second component.

14. The non-transitory machine-readable storage medium of claim 11, further comprising instructions to:
update a third component firmware associated with a third component of the external device at a second level upon successfully completing the update of the first component firmware and the second component firmware, wherein the third component is to have a dependency relationship with the first component or the second component.

15. The non-transitory machine-readable storage medium of claim 11, wherein instructions to trigger the firmware update of the external device comprise instructions to:
trigger the firmware update of the external device in response to receiving a user input.
